(19) United States
(12) Patent Application Publication
(10) Pub. No.: US 2003/0094261 A1
(43) Pub. Date: May 22, 2003

(54) Heating-air conditioning installation for vehicles

(76) Inventor: Nicolas Abouchaar, Bad Rodach (DE)

Correspondence Address: Liniak Berenato, Longacre & White, Suite 240, 6550 Rock Spring Drive, Bethesda, MD, 20817, US

(21) Appl. No.: 10/258,843

(22) PCT Filed: Oct. 19, 2001
(86) PCT No.: PCT/FR01/03266

(30) Foreign Application Priority Data
Oct. 20, 2000 (DE) 100 52 136.3

(51) Int. Cl. B60H 3/00; B61D 27/00; F28F 27/02

(52) U.S. Cl. 165/42; 165/43; 165/103; 454/156; 237/12.3 A; 237/12.3 B

(57) ABSTRACT

The invention concerns a heating-air conditioning installation for a vehicle, comprising an evaporator (10) and a heating element (12, 14), a fan and various air outlet channels (2, 4, 6), at least means controlling the air stream (20) being placed beside the evaporator (10), according to fluid mechanics. In different positions of the air stream control means, part of the heating-air conditioning installation can be traversed by air in different directions, so that a bypass channel relative to the evaporator may be produced without requiring additional structural volume.

The present invention relates in general to a heating-air conditioning installation and, in particular, to a heating-air conditioning installation for a vehicle. Customarily, such a heating-air conditioning installation comprises an evaporator, a heater body and a fan, so as to cause the air to pass successively through the evaporator and the heater body, so that it can be diffused to the desired points, after having been treated, by various air outlet ducts. In a motor vehicle, it is desirable for example to diffuse the treated air as selected in the region of the feet, to the dashboard and above the dashboard toward the windshield.

In recent years, attempts have been made at providing different temperature levels in different air outlet ducts, it being possible for this to be achieved using means of controlling the air flow and/or by controlling the air treatment devices.

As there was a desire to be able to guide the untreated fresh air optionally into the vehicle cabin, attempts were made at supplying additional air ducts for the fresh air, which usually bypassed the entire air conditioning installation or which also ran partially along inside the air conditioning unit, and this led to an increase in the construction volume needed for the entire installation or to disturbed operation.

Another desire of a general nature consists in being able to supply the vehicle cabin with air while at the same time maintaining minimal fan power, so as to be able for example to maintain a comfortable temperature in the cabin when the vehicle engine is switched off, or at least to be able to adjust it at will.

The objective of the present invention is therefore to provide a heating-air conditioning installation which takes account of the above desires and which requires an additional construction volume that is as small as possible, or even no additional construction volume.

According to the invention, this objective is achieved by a heating-air conditioning installation having the characteristics of claim 1. Preferred improvements are indicated in the dependent claims.

In particular, the invention proposes a heating-air conditioning installation, particularly for a vehicle, which has an evaporator and a heater body, a fan and various air outlet ducts, at least one means of controlling the air stream being placed beside the evaporator, from the point of view of the art of fluid mechanics, so as to be able to close and open an air path bypassing the evaporator and opening into an air outlet duct, which air path may be traversed by the air stream at least by sections in another direction in the event that the means of controlling the air stream is closed. In other words, the invention proposes to use a space inside the heating-air conditioning installation in a dual-purpose way, that is to say, on the one hand, within the conventional meaning of a heating-air conditioning installation and, on the other hand, as a path for the air which does not pass through the evaporator. This configuration makes it possible to supply an air path which does not pass through the evaporator, with practically no additional bulk, and thus makes it possible to guide through it air which has been supplied with only a minimum fan power. The installation according to the invention can also be used in such a way that the air pass through the evaporator and past it simultaneously.

In a preferred form of embodiment, the air path bypassing the evaporator, that can be uncovered by the means of controlling the air stream, can be traversed at least in sections, by air essentially at right angles to it, when the means of controlling the air stream is closed. By way of example only, air could, in a conventional operation of a heating-air conditioning installation, pass in succession through an evaporator then through a heater body, so as then to be deflected essentially upward, toward diffusers which may feed the windshield. If now fresh air is allowed to pass essentially horizontally through this duct running upward, in order for example to lead to diffusers in the dashboard, then this space is in consequence used in a dual-purpose manner. Obviously, other spaces in the installation could also be used in a corresponding way in different directions, such as, for example, a space running horizontally, which guides the air toward one or more ducts used to feed the foot part, in the conventional mode of operation.

In another preferred form of embodiment, the air path that can be uncovered by the means of controlling the air stream bypassing the evaporator can, when the means of controlling the air stream is closed, be traversed by air essentially in the opposite direction to that taken when the means of controlling the air stream is open. For such a form of embodiment, a duct which, during usual operation, serves to convey the air upward, may, for example, be used to guide untreated air or at least air bypassing the evaporator, toward a lower section of the vehicle.

Independently of the fact that the different direction is now perpendicular, the opposite or otherwise, it should be pointed out that the means of controlling the air stream may, in the closed position, form part of the wall of the duct portion involved.

Advantageously, the means of controlling the air stream is provided above the evaporator and, in particular, near one of the air outlet ducts. Thanks to this configuration, it is possible to set the shortest route from the fan to the outlet location, so that the flow losses and/or pressure drops are minimized at least for some of the air passing along this route.

Furthermore, it is advantageous for the air path that can be uncovered by the means of controlling the air stream, and which bypasses the evaporator, to be able to pass directly into at least one air outlet duct, particularly without passing via an air treatment device. For this particular path, there can therefore be no pressure drops, either through the evaporator or through a heat exchanger for heating or any additional heating appliance that might be present.

The heating-air conditioning installation according to the invention may at least contain one other means of controlling the air stream, which can uncover and block an air passage toward a space between the evaporator and the heater body. By virtue of this additional means of controlling the air stream, other different air paths can be made available for the air which does not pass through the evaporator. For example, two air streams, namely one passing past the evaporator, or through the evaporator, can be mixed, from the point of view of the art of fluid mechanics, behind the evaporator, so as to regulate the air guided toward the various diffusers, in terms of temperature and/or in terms of humidity, or in any case to influence it.

In one preferred form of embodiment, the air path that can be uncovered by the means of controlling the air stream and bypassing the evaporator, runs in particular through the air passage uncovered by the other means of controlling the air stream, between the evaporator and the heater body. Guidance of the air bypassing the evaporator between the evaporator and the heater body may be advantageous in that this space usually contains no resistance to flow, for example by other air guiding elements or the like, and above all, this space is appropriate for preventing, during normal operation of the heating/air conditioning, drops of moisture forming on the evaporator from affecting the heater body and going so far as to damage it.

Advantageously, the air in the air path that can be uncovered by the means of controlling the air stream and bypassing the evaporator may pass past the evaporator and/or the heater body essentially tangentially, so that any residual heating or cooling that might be present can be absorbed, without this resulting in a pressure drop by flowing through an air treatment device.

Furthermore, it is preferable to provide yet another means of controlling the air stream so as to cause at least some of the air to pass through the heater body. To this end, it should be mentioned that a successive passage through a heat exchanger for heating and an additional heating device, for example a PTC heating element and a selective passage through one of these elements may be achieved. For example, it is thus possible to preheat the driving cabin by means of an electric heating device, the low power required to supply air through the fan being something to emphasize, in that any current saving when the engine is not running is to be considered as favorable.

Finally, it is preferable for the air path that can be uncovered by the means of controlling the air stream, and bypasing the evaporator to run at least in a direction through at least one heater body which is essentially the opposite direction to the direction in which the air leaves the evaporator. In this form of embodiment, it is thus possible to envisage use of residual heat for minimum pressure drops, and preheating of the vehicle cabin for minimum pressure drops.

To sum up, it can be specified that the heating-air conditioning installation according to the invention allows air to be supplied to the cabin interior with minimal requirements in terms of power at the fan, without requiring an additional construction volume. An advantageous parallel phenomenon is that the heating-air conditioning installation according to the invention also allows the humidity in the cabin interior to be regulated because the air which has not passed through regularly has a higher relative humidity. Thus, for example, when the heating-air conditioning installation is in normal operation, if one duct, for example for supplying the rear part, is not required, this duct can be used as an air path for air that bypasses the evaporator and can thus bring moisture into the cabin. In other words, the heating-air conditioning installation according to the invention can also be used as an auxiliary ventilation and/or heating appliance in addition to its usual heating-air conditioning mode of operation, in which some of the air can enter the cabin interior in untreated form, but nonetheless at least without passing through the evaporator.

Other advantages and features of the present invention result from the description given by way of example only of one currently preferred form of embodiment which refers to the accompanying drawings in which:

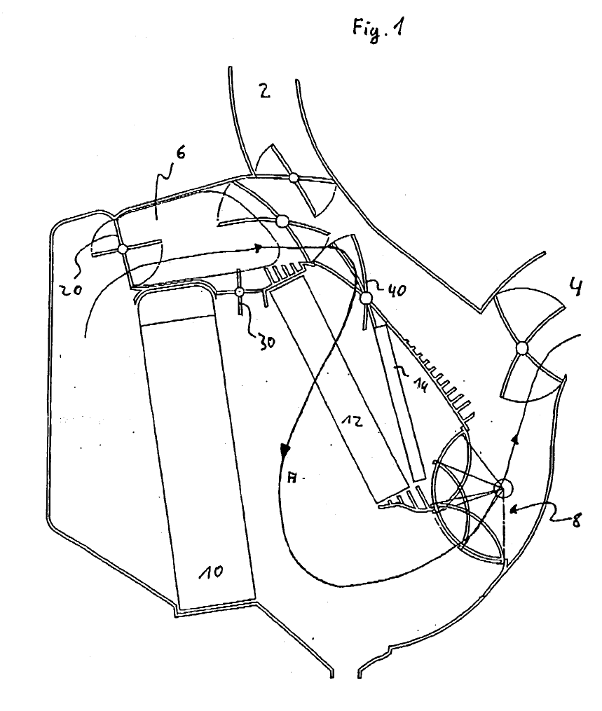

FIGS. 1 to 5 illustrate schematically in a sectioned view a heating-air conditioning installation by way of a preferred form of embodiment of the invention, various air paths for the air bypassing the evaporator being indicated in the various figures.

FIG. 1 illustrates, in schematic section, a heating-air conditioning installation which can be supplied with air via a fan, not illustrated. The heating-air conditioning installation illustrated comprises, in the conventional way, an evaporator 10, a heater body 12 and an electric heating device 14, which in the form of embodiment illustrated is of the PTC (Positive Temperature Coefficient) type. The installation further comprises various means of controlling the air, which means may be produced entirely or partially in the form of mixing valves and may also find themselves in any intermediate positions between an open position and a closed position, in the form of embodiment illustrated in the form of butterfly valves and of a shell valve 8, so that various air outlet ducts 2, 4, 6 can be supplied with air adjustably. In the form of embodiment illustrated, the air outlet duct 2 is used to supply nozzles which open directly at windshield level, so as to be able for example to prevent the latter from misting. The air outlet duct 4 is connected to diffusers, not illustrated, in the dashboard, while an air outlet duct 6 extends toward the interior of the plane of the drawing to lead, past the heating-air conditioning unit, toward diffusers in the region of the feet or also toward diffusers arranged laterally.

In the form of embodiment illustrated, the air outlet duct 6 is to be considered as a duct the supply to which can be shut off the most easily without considerably impairing passenger comfort. In this context, it is also possible to conceive of the air outlet duct 6 serving to supply the part right at the back, in which case it would be possible to use this only when needed, that is to say when the passengers are right at the back of the vehicle.

The form of embodiment illustrated, unlike the heating-air conditioning installations hitherto known, has a means 20 of controlling the air stream which, in the closed position, allows the air outlet duct 6 to be supplied in the usual way, in that the element 20 for controlling the air stream defines a wall of the space connected to it. Under the means of controlling the air stream there is also, in the form of embodiment illustrated, a means 30 of controlling the air stream which allows passage toward the space between the evaporator 10 and the heater body 12, and a means 40 of controlling the air stream which can fulfill various functions for various modes of operation, namely, on the one hand, when the element 20 for controlling the air stream is closed, deflecting the air which has passed through the evaporator 10 and the heater body 12 toward the air outlet duct 2 and/or 6, while the means 40 for controlling the air stream, when the means 20 for controlling the air stream is open, serves to allow the air which has passed past the evaporator 10 to pass through the heater body 12.

The air paths A, B, C, D, E illustrated in FIGS. 1 to 5 will be examined hereafter solely by way of example:

In the configuration of the air path A, as illustrated in FIG. 1, it may for example be an auxiliary mode of operation of the heating-air conditioning installation in which mode it is desirable to convey residual heat from the heater body 12 into the cabin, for example via the air outlet duct 4. In this case, the means 20 of controlling the air stream is in the open position so that the duct portion behind in normal operation is traversed in the opposite direction by the stream, so as to allow the air to reach the means 40 of controlling the air stream which directs the air through the heater body 12 after which, for a corresponding position of the shell valve 8, for example in the form of an air mixing valve, the air can pass into the air outlet duct 4. Although this is not illustrated, it should be pointed out that some of this air flow could also leak through the air outlet duct 2 if the means of controlling the air stream is in a corresponding position, which means that even for a low air flow rate, that is to say using a low fan power, it is possible to graduate the temperature inside the cabin.

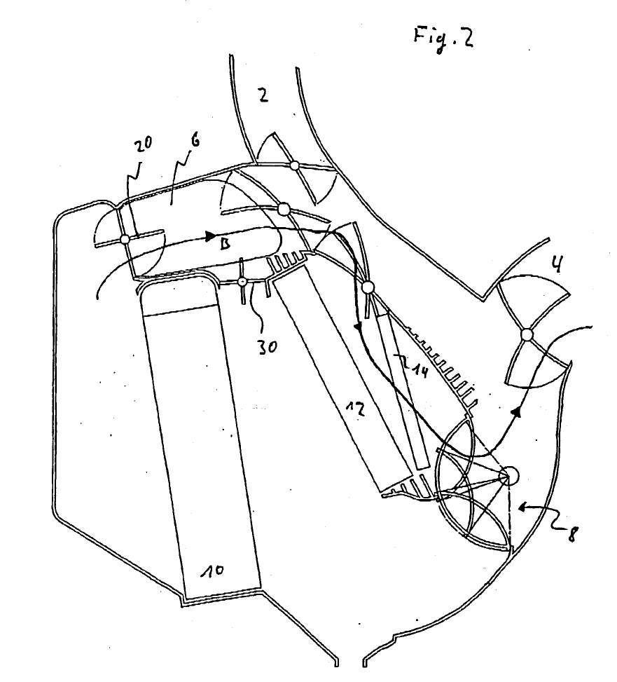

In the case of the air path illustrated in FIG. 2, the air passes, instead of through the heat exchanger for heating 12, through the additional heating appliance which could, for example, be an electric heating appliance or also any other additional heating appliance. Thus, as illustrated, auxiliary heating independent of the engine may be achieved.

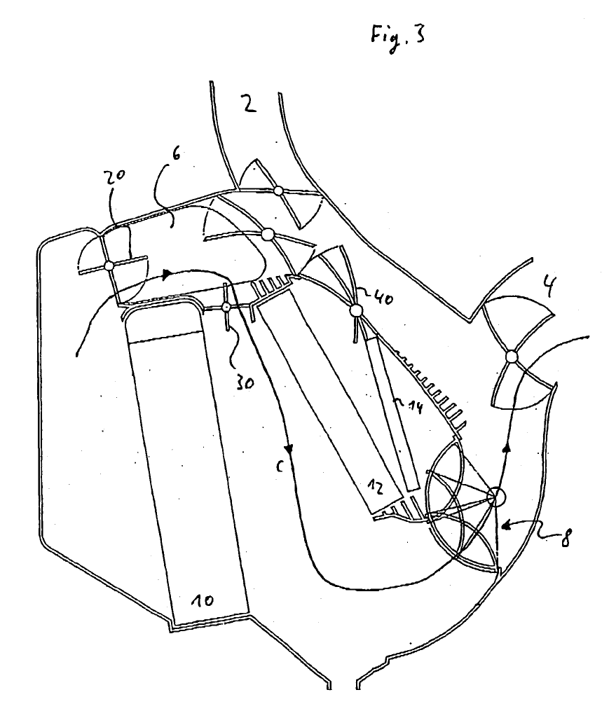

In the case illustrated in FIG. 3, the air path bypassing the evaporator, which path is uncovered by the means 20 of controlling the air stream, runs between the evaporator 10 and the heater body 12, the additional means 30 of controlling the air stream being for that reason arranged in the open position. This configuration makes efficient use of a space between the evaporator 10 and the heater body 12, the direction of the flow indicated being essentially perpendicular to the direction of flow that they normally use. After the air has thus passed against the evaporator 10, through the means 20 of controlling the air stream and between the evaporator 10 and the heat exchanger for heating 12, it can, by passing through the shell valve 8, get as far as the air outlet duct 4.

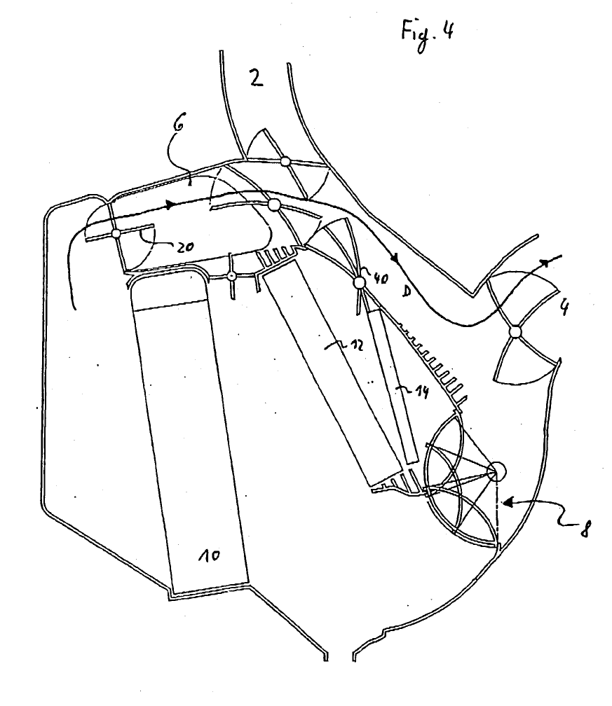

FIG. 4 illustrates another configuration of possible air path in the form of a branch away from all the air treatment devices, namely the evaporator 10, the heat exchanger for heating 12 and the electric heating device 14. The air path D thus runs over these air treatment devices and thus opens directly into the vehicle cabin to which it supplies fresh air and/or humidity. The person skilled in the art will recognize that this configuration of the air path D could also end directly in the air outlet duct 2. In this case, simultaneous operation of the heating-air conditioning installation would also be possible, so as to supply the air outlet duct 4 with air which has been treated in succession by the evaporator 10, the heater body 12 and the additional heating device 14, while in the region of the windshield, only fresh air is diffused, the fresh air being guided through a space which could alternatively, when the element 20 for controlling the air stream is closed, be used for supplying the air outlet duct 6.

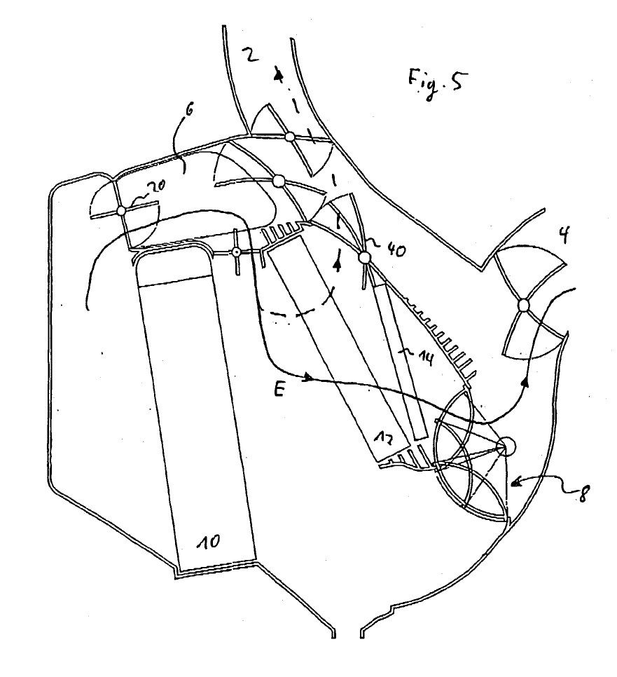

Finally, FIG. 5 illustrates yet another possible configuration for an air path, which bypasses the evaporator 10, but which does however pass through the heat exchanger for heating 12 and/or the electric heating device 14. This air path makes it possible, for example in normal operation, provided the air outlet opening 6 does not have to be supplied, for humidity to be conveyed into the cabin via air-conditioned and possibly then heated air, particularly in the case of very low external temperatures, for which the humidity of the air is naturally low.

Although the present invention has been described previously completely and by way of example with reference to a preferred form of embodiment, the person skilled in the art will recognize that very diverse modifications are possible in the scope of the claims, and in that context it should be emphasized that very diverse air paths can be represented, for example also combinations of the paths described by way of example or also paths which branch. The important thing is that part of the heating-air conditioning installation can be used in a dual-purpose way, namely in the form of a branch path branching away from the evaporator 10 and, on the other hand, as a conventional path for guiding the air in which, in the various modes, the air flows involved adopt, at least in sections, different directions, for example directions perpendicular or opposite to one another.

1. A heating-air conditioning installation, particularly for a vehicle, comprising an evaporator (10) and a heater body (12, 14), a fan and various air outlet ducts (2, 4, 6), at least one means (20) of controlling the air stream being placed beside the evaporator (10), from the point of view of the art of fluid mechanics, so as to be able to uncover and close an air path (A, B, C, D, E) bypassing the evaporator (10) and opening into an air outlet duct (2, 4), which air path may be traversed by the air stream at least by sections in another direction in the event that the means (20) of controlling the air stream is closed.

2. The heating-air conditioning installation as claimed in claim 1, in which the air path (A, B, C, D, E) that can be uncovered by the means (20) of controlling the air stream, and bypassing the evaporator (10) can be traversed at least in sections, by the air stream essentially at right angles to it, when the means (20) of controlling the air stream.

3. The heating-air conditioning installation as claimed in claim 1 or 2, in which the air path (A, B, C, D, E) that can be uncovered by the means (20) of controlling the air stream and bypassing the evaporator (10) can be traversed by the air stream essentially in the opposite direction when the means (20) of controlling the air stream is closed.

4. The heating-air conditioning installation as claimed in claims 1 to 3, in which the means (20) of controlling the air stream is provided above the evaporator (10), in particular near an air outlet duct (6).

5. The heating-air conditioning installation as claimed in any of the preceding claims, in which the air path (A, B, C, D, E) that can be uncovered by the means (20) of controlling the air stream and bypassing the evaporator (10), opens directly, particularly without passing through an air treatment device (10, 12, 14) into at least one air outlet duct (6).

6. The heating-air conditioning installation as claimed in any of the preceding claims, in which at least one other means (30) of controlling the air stream is provided and can uncover and block an air passage toward a space between the evaporator (10) and the heater body (12, 14).

7. The heating-air conditioning installation as claimed in claim 6, in which the air path (A, B, C, D, E) that can be uncovered by the means (20) of controlling the air stream and bypassing the evaporator (10) runs at least partially between the evaporator (10) and the heater body (12, 14).

8. The heating-air conditioning installation as claimed in any of the preceding claims, in which the air path (A, B, C, D, E) that can be uncovered by the means (20) of controlling the air stream and bypassing the evaporator (10) can pass essentially tangentially past the evaporator (10) and/or the heater body (12, 14).

9. The heating-air conditioning installation as claimed in any of the preceding claims, in which another means (40) of controlling the air stream is provided so as to allow some of the air to pass through the heater body (12, 14).

10. The heating-air conditioning installation as claimed in any of the preceding claims, in which the air path (A, B, C, D, E) that can be uncovered by the means (20) of controlling the air stream and bypassing the evaporator (10) runs at least partially across at least a heater body (12, 14) in a direction which is essentially the opposite direction to the direction in which the air passing through the evaporator flows.
